(19) United States
(12) Patent Application Publication
(10) Pub. No.: US 2019/0199426 A1
(43) Pub. Date: Jun. 27, 2019

(54) BASE STATION DEVICE, NOTIFICATION METHOD, NOTIFICATION SYSTEM, UNMANNED AIRCRAFT, AND COMMUNICATION TERMINAL

(71) Applicant: SHARP KABUSHIKI KAISHA, Sakai City, Osaka (JP)

(72) Inventors: TAKUYA OHKUBO, Sakai City, Osaka (JP); SHUNSUKE YAJIMA, Sakai City, Osaka (JP); HIROYUKI KATATA, Sakai City, Osaka (JP); YOSHITAKA SUZUKI, Sakai City (JP); YASUO SUGAWARA, Sakai City (JP); SHIGETO SUZUKI, Sakai City (JP)

(21) Appl. No.: 16/329,709

(22) PCT Filed: Aug. 24, 2017
(86) PCT No.: PCT/JP2017/030304

§ 371 Date: Feb. 28, 2019

(30) Foreign Application Priority Data
Sep. 7, 2016 (JP) 2016-175043

(51) Int. Cl. H04B 7/185; B64C 39/02

(52) U.S. Cl. CPC H04B 7/18506; B64C 2201/122; B64C 39/024

(57) ABSTRACT

A base station device includes: a detection unit that detects approach of a mobile station device; a determination unit that determines whether or not the detected mobile station device is an unmanned aircraft; and a notification unit that notifies of the approach of the mobile station device in a case that it is determined that the mobile station device is an unmanned aircraft.

### TECHNICAL FIELD

Several aspects of the present invention relate to a base station device, a notification method, a notification system, an unmanned aircraft, and a communication terminal.

Priority is claimed on Japanese Patent Application No. 2016-175043, filed Sep. 7, 2016, the content of which is incorporated herein by reference.

### BACKGROUND ART

Currently, small unmanned aircrafts such as drones are widespread, but since cameras are generally mounted on unmanned aircrafts, from the viewpoint of privacy protection, there is a desire to know that the unmanned aircrafts has approached a house or the like in a case that the unmanned aircrafts have approached the house or the like. Patent Document 1 describes a technology in which a flying object outputs a predetermined warning in a case that the flying object approaches an obstacle or a prohibited flight area in a case that coordinates of the obstacle or the prohibited flight area have been input in advance.

### PRIOR ART DOCUMENT

### Patent Document

### [Patent Document 1] Japanese Unexamined Patent Application, First Publication No. 2003-127997

### SUMMARY OF THE INVENTION

### Problem to Be Solved by the Invention

However, in the technology described in Patent Document 1, there is a problem that the warning cannot be output unless coordinates of a target are set in the flying object in advance.

Several aspects of the present invention have been made in view of the above circumstances, and an object of the present invention is to provide a base station device, a notification method, a notification system, an unmanned aircraft, and a communication terminal capable of notifying of approach of the unmanned aircraft without information on a target being input to the unmanned aircraft in advance.

### Means for Solving the Problems

Some aspects of the present invention are made to solve the above-described problem, and a first aspect of the present invention is a base station device including: a detection unit that detects approach of a mobile station device; a determination unit that determines whether or not the detected mobile station device is an unmanned aircraft; and a notification unit that notifies of the approach of the mobile station device in a case that it is determined that the mobile station device is an unmanned aircraft.

In addition, a second aspect of the present invention is a notification method in a base station device, the notification method including: a detection step of detecting approach of a mobile station device; a determination step of determining whether or not the detected mobile station device is an unmanned aircraft; and a notification step of notifying of the approach of the mobile station device in a case that it is determined that the mobile station device is an unmanned aircraft.

In addition, a third aspect of the present invention is a notification system including an unmanned aircraft, a base station device, and a communication terminal, wherein the base station device includes a wireless communication unit and a control unit, the control unit of the base station device assigns a message identifier, and transmits the assigned message identifier to the unmanned aircraft and the communication terminal via the wireless communication unit, the unmanned aircraft includes a wireless communication unit and a control unit, the control unit of the unmanned aircraft receives a message identifier transmitted by the base station device via the wireless communication unit, and informs of an approach notification including the message identifier via the wireless communication unit, the communication terminal includes an output unit, a wireless communication unit, and a control unit, and the control unit of the communication terminal causes the output unit to output information on the approach of the unmanned aircraft in a case that the approach notification of which the unmanned aircraft has informed is received via the wireless communication unit.

In addition, a fourth aspect of the present invention is an unmanned aircraft including a wireless communication unit and a control unit, wherein the control unit receives a message identifier transmitted by a base station device via the wireless communication unit, and informs of an approach notification including the message identifier via the wireless communication unit.

In addition, a fifth aspect of the present invention is a communication terminal including an output unit, a wireless communication unit, and a control unit, wherein the control unit causes the output unit to output information on approach of an unmanned aircraft in a case that approach notification of which the unmanned aircraft has informed is received via the wireless communication unit.

### Effect of the Invention

According to some aspects of the present invention, it is possible to notify of approach of an unmanned aircraft without information on a target being input to the unmanned aircraft in advance.

### BRIEF DESCRIPTION OF THE DRAWINGS

FIG. 1 is a schematic diagram illustrating an example of a configuration of a notification system according to a first embodiment of the present invention.

FIG. 2 is a schematic diagram illustrating an example of a configuration of a home base station according to the first embodiment.

FIG. 3 is a schematic diagram illustrating an example of a configuration of an unmanned aircraft according to the first embodiment.

FIG. 4 is a sequence diagram illustrating a notification process according to the first embodiment.

FIG. 5 is a sequence diagram illustrating a notification process according to a second embodiment of the present invention.

FIG. 6 is a schematic diagram illustrating an example of a configuration of a notification system according to a third embodiment of the present invention.

FIG. 7 is a schematic diagram illustrating an example of a configuration of a macrocell base station according to the third embodiment.

FIG. 8 is a sequence diagram illustrating a notification process according to the third embodiment.

FIG. 9 is a schematic diagram illustrating an example of a configuration of a notification system according to a fourth embodiment of the present invention.

FIG. 10 is a schematic diagram illustrating an example of a configuration of a communication terminal according to the fourth embodiment.

FIG. 11 is a sequence diagram illustrating a notification process according to the fourth embodiment.

### EMBODIMENTS FOR CARRYING OUT THE INVENTION

Hereinafter, embodiments of the present invention will be described in detail with reference to the drawings. It should be noted that in the drawings, the same portions are denoted by the same reference numerals.

### First Embodiment

First, a first embodiment of the present invention will be described.

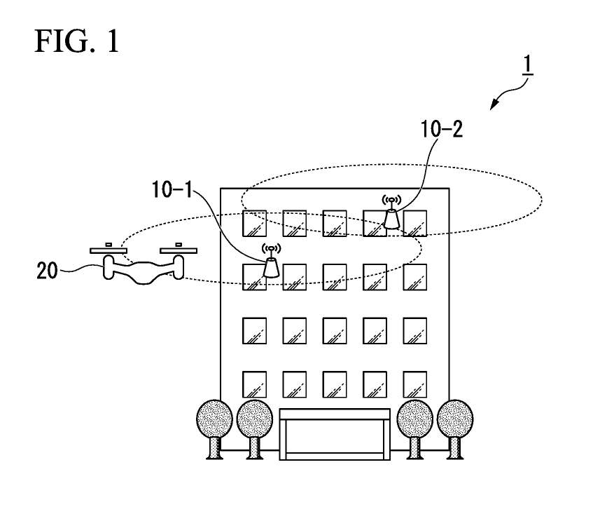

FIG. 1 is a schematic diagram illustrating an example of a configuration of a notification system 1 according to the first embodiment.

As illustrated in FIG. 1, the notification system 1 includes home base stations 10-1 and 10-2 and an unmanned aircraft 20. Hereinafter, the home base stations 10-1 and 10-2 may be collectively referred to as a home base station 10.

The home base station 10 includes a small base station device (a home eNodeB [indoor base station device], a micro cell eNodeB [micro cell base station device]), a pico cell eNodeB [picocell base station device], or a femto cell eNodeB [femtocell base station device]) which wirelessly transmits and receives data to and from a mobile station device (user equipment). A radius of a cell (a range that radio waves reach) in which the home base station 10 provides a service is a relatively narrow range of, for example, several meters to tens of meters. That is, the home base station 10 is a base station device having a narrow range (typically, a radius of several meters to tens of meters) in which communication with the mobile station device is possible. The home base station 10 is installed, for example, in each residential space of an apartment. Further, the home base stations 10-1 and 10-2 are communicably connected to each other via a network. In the first embodiment, the number of the home base stations 10 is not limited to two as illustrated and may be one or may be more than two.

The unmanned aircraft 20 is, for example, a drone and is a small aircraft capable of performing flight in an unmanned manner through remote control or automatic control. The unmanned aircraft 20 is a mobile station device that wirelessly transmits and receives data to and from the home base station 10. In the first embodiment, the number of unmanned aircrafts 20 is not limited to one and may be more than one.

Next, an overview of the notification system 1 will be described.

The unmanned aircraft 20 searches its surroundings, detects the home base station 10 to which the unmanned aircraft 20 can connect, and performs flight while connecting to the detected home base station 10. The home base station 10 determines whether or not the mobile station device that has performed the connection procedure is the unmanned aircraft 20. In the connection procedure, the mobile station device transmits a unique identifier (ID) of the mobile station device, an identifier indicating a model of the mobile station device, communication capability of the mobile station device, and a reason for a connection request to the home base station 10. For example, in a case that information indicating the unmanned aircraft 20 is included in the unique identifier, the home base station 10 determines whether or not the mobile station device is the unmanned aircraft 20 based on the unique identifier. Alternatively, the home base station 10 may send the received unique identifier to a server device and inquire about whether or not the mobile station device is the unmanned aircraft 20.

In a case that the home base station 10 determines that the connected mobile station device is the unmanned aircraft 20, the home base station 10 notifies of the approach of the unmanned aircraft 20. For example, the home base station 10 outputs a warning message (information on the approach) for notifying of the approach of the unmanned aircraft 20 as sound. Alternatively, the home base station 10 displays the warning message (the information on the approach) for notifying of the approach of the unmanned aircraft 20. Accordingly, a person near the home base station 10 can know of the approach of the unmanned aircraft 20.

Next, a configuration of the home base station 10 according to the first embodiment will be described.

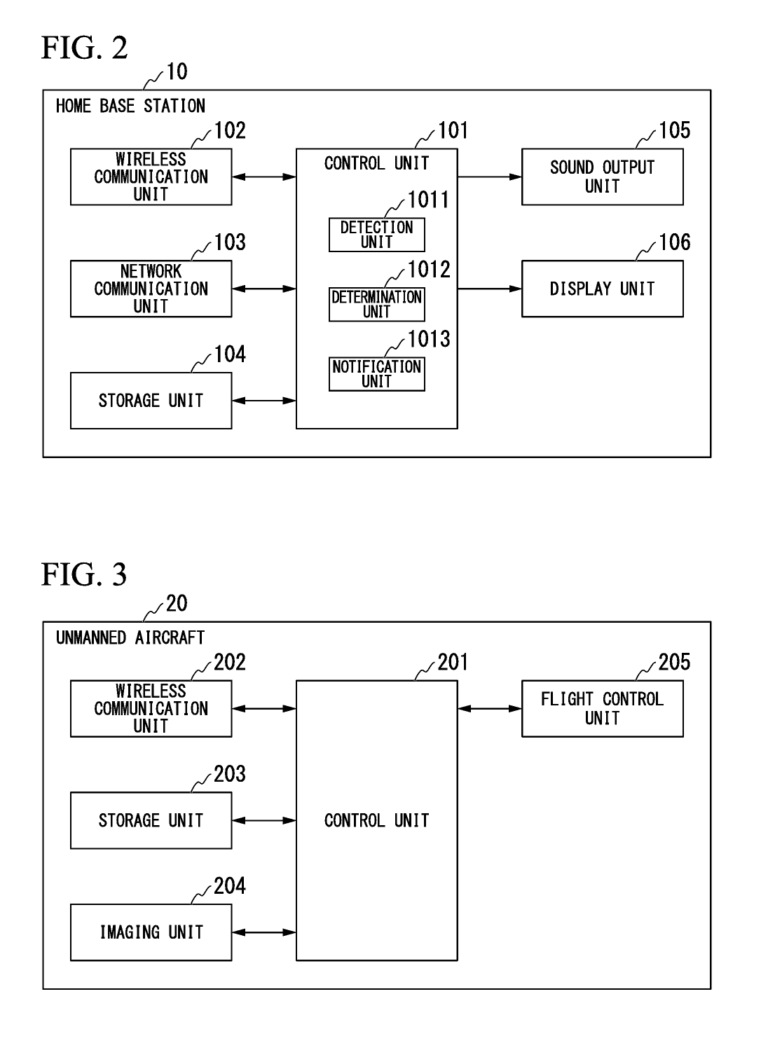

FIG. 2 is a schematic diagram illustrating an example of the configuration of the home base station 10 according to the first embodiment. The home base station 10 includes a control unit 101, a wireless communication unit 102, a network communication unit 103, a storage unit 104, a sound output unit 105, and a display unit 106.

The control unit 101 includes a detection unit 1011, a determination unit 1012, and a notification unit 1013, and controls the home base station 10. The detection unit 1011 detects approach of the mobile station device. For example, the detection unit 1011 detects the approach of the mobile station device based on information that the mobile station device has transmitted based on informing information. Specifically, the detection unit 1011 determines that the mobile station device has approached in a case that a connection procedure with the mobile station device has been performed via the wireless communication unit 102. The determination unit 1012 determines whether or not the detected mobile station device is the unmanned aircraft 20. For example, the determination unit 1012 determines whether or not the mobile station device is the unmanned aircraft 20 based on the information received from the mobile station device in the connection procedure. In a case that it is determined that the mobile station device is the unmanned aircraft 20, the notification unit 1013 notifies of the approach of the unmanned aircraft 20. For example, the notification unit 1013 causes the sound output unit 105 to output a warning message for notifying of the approach of the unmanned aircraft 20 as sound.

Alternatively, the notification unit 1013 causes the display unit 106 to display the warning message for notifying of the approach of the unmanned aircraft 20.

The wireless communication unit 102 wirelessly communicates with the mobile station device. The network communication unit 103 communicates with another communication device such as the home base station 10 via a network. The storage unit 104 stores various pieces of data (including informing information) to be used by the home base station 10. The sound output unit 105 is a speaker that outputs sound. The display unit 106 includes a light emitting diode (LED) or a liquid crystal display and displays information. The sound output unit 105 or the display unit 106 constitutes an output unit that outputs information on the approach of the unmanned aircraft 20.

Next, the configuration of the unmanned aircraft 20 according to the first embodiment will be described.

FIG. 3 is a schematic diagram illustrating an example of a configuration of the unmanned aircraft 20 according to this embodiment. The unmanned aircraft 20 includes a control unit 201, a wireless communication unit 202, a storage unit 203, an imaging unit 204, and a flight control unit 205.

The control unit 201 controls the unmanned aircraft 20. The wireless communication unit 202 wirelessly communicates with a base station device such as the home base station 10. The storage unit 203 stores various types of information to be used by the unmanned aircraft 20. The imaging unit 204 is a camera that images its surroundings. The flight control unit 205 controls a moving direction, a moving speed, and the like of the unmanned aircraft 20.

Next, a notification process according to the first embodiment will be described.

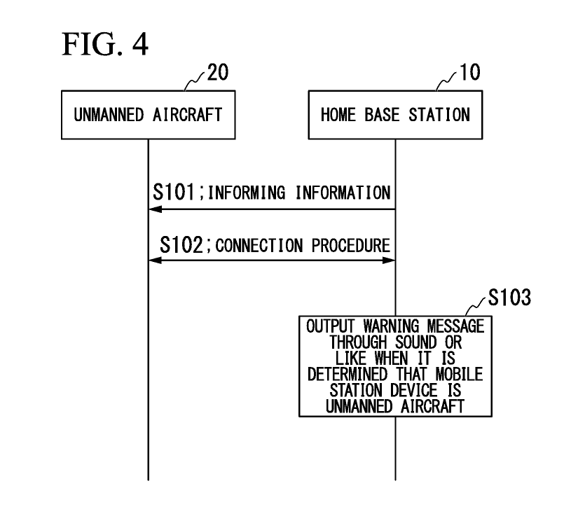

FIG. 4 is a sequence diagram illustrating a notification process according to the first embodiment.

(Step S101) The home base station 10 regularly transmits informing information.

(Step S102) In a case that the unmanned aircraft 20 receives the informing information from the home base station 10, the unmanned aircraft 20 performs a connection procedure with the home base station 10 based on the received informing information.

(Step S103) In a case that the home base station 10 determines that a mobile station device that has performed the connection procedure is the unmanned aircraft 20, the home base station 10 outputs a warning message for notifying of approach of the unmanned aircraft 20 as a sound or the like. Thereafter, the process ends.

In a case that the connection with the unmanned aircraft 20 is released, the home base station 10 may notify that the unmanned aircraft 20 has left.

As described above, according to the first embodiment, the notification system 1 includes the home base station 10 and the unmanned aircraft 20. The home base station 10 includes the detection unit 1011 that detects the approach of the mobile station device, the determination unit 1012 that determines whether or not the detected mobile station device is the unmanned aircraft 20, and the notification unit 1013 that notifies of the approach of the mobile station device in a case that it is determined that the mobile station device is the unmanned aircraft 20. The detection unit 1011 detects the approach of the mobile station device based on the connection procedure based on the informing information. The notification unit 1013 causes the sound output unit 105 or the display unit 106 to output the warning message for notifying of the approach of the unmanned aircraft 20.

Accordingly, it is possible to notify of the approach of the unmanned aircraft 20 without information on a target being input to the unmanned aircraft 20 in advance. Therefore, it is possible to output a warning about the approach of an unknown unmanned aircraft 20.

### Second Embodiment

Next, a second embodiment of the present invention will be described. Since a configuration of a notification system 1 according to the second embodiment is the same as that according to the first embodiment, description thereof will be omitted. In the second embodiment, the home base station 10 is different from that in the first embodiment in that other nearby home base stations 10 are also notified of the approach of the unmanned aircraft 20.

In a case that it is determined that the mobile station device is the unmanned aircraft 20, the notification unit 1013 of the home base station 10 in the second embodiment causes the sound output unit 105 or the display unit 106 to output a warning message for notifying of the approach of the unmanned aircraft 20 and transmits an unmanned aircraft approach notification (informing information) for notifying of the approach of the unmanned aircraft 20 to the nearby home base stations 10 via the network communication unit 103. Information on the nearby home base stations 10 is preset and stored in the storage unit 104. In a case that the notification unit 1013 receives the unmanned aircraft approach notification from the other home base station 10 via the network communication unit 103, the notification unit 1013 causes the sound output unit 105 or the display unit 106 to output a warning message for notifying of the approach of the unmanned aircraft 20.

Next, a notification process according to the second embodiment will be described.

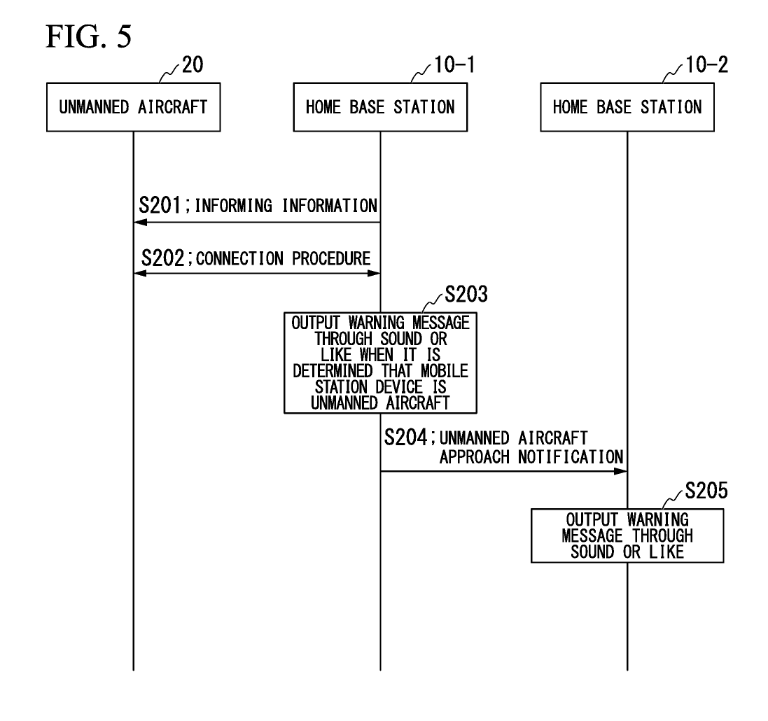

FIG. 5 is a sequence diagram illustrating a notification process according to the second embodiment.

FIG. 5 illustrates a process in a case that the home base station 10-1 and the home base station 10-2 are approaching.

Since processes from step S201 to step S203 are the same as the processes from step S101 to step S103 described above, description thereof will be omitted.

(Step S204) The home base station 10-1 transmits an unmanned aircraft approach notification to the nearby home base station 10-2.

(Step S205) In a case that the home base station 10-2 receives the unmanned aircraft approach notification, the home base station 10-2 outputs a warning message for notifying of the approach of the unmanned aircraft 20 as a sound or the like. Thereafter, the process ends.

As described above, according to the second embodiment, the notification system 1 includes the home base station 10 and the unmanned aircraft 20. The home base station 10 includes the detection unit 1011 that detects the approach of the mobile station device, the determination unit 1012 that determines whether or not the detected mobile station device is the unmanned aircraft 20, and the notification unit 1013 that notifies of the approach of the mobile station device in a case that it is determined that the mobile station device is the unmanned aircraft 20. The detection unit 1011 detects the approach of the mobile station device based on the connection procedure based on the informing information. The notification unit 1013 causes the sound output unit 105 or the display unit 106 to output the warning message for notifying of the approach of the unmanned aircraft 20, and notifies the other home base station 10 of the approach of the unmanned aircraft 20. The notification unit 1013 of the home base station 10 having received the notification of the approach of the unmanned aircraft 20 causes the sound output unit 105 or the display unit 106 to output the warning message for notifying of the approach of the unmanned aircraft 20.

The unmanned aircraft 20 performs the connection procedure with only one base station device and does not perform the connection procedure with a plurality of base station devices at the same time. Therefore, in the first embodiment, in a case that the unmanned aircraft 20 has approached a plurality of base station devices at the same time, only one of the plurality of base station devices can notify of the approach of the unmanned aircraft 20. That is, in a case that the plurality of base station devices are at positions close to each other, base station devices other than the one base station that has performed the connection procedure with the unmanned aircraft 20 cannot notify of the approach of the unmanned aircraft 20. On the other hand, in the second embodiment, since the home base station 10 connecting to the unmanned aircraft 20 notifies other nearby home base stations 10 of the approach of the unmanned aircraft 20, the other home base stations 10 can also output a warning message for notifying of the approach of the unmanned aircraft 20. That is, even in a case that the unmanned aircraft 20 has approached the plurality of home base stations 10 at the same time, the plurality of home base stations 10 can notify of the approach of the unmanned aircraft 20 substantially at the same time. Accordingly, it is possible to notify of the approach of the unmanned aircraft 20 without information on a target being input to the unmanned aircraft 20 in advance. Therefore, it is possible to output a warning about the approach of an unknown unmanned aircraft 20.

### Third Embodiment

Next, a third embodiment of the present invention will be described.

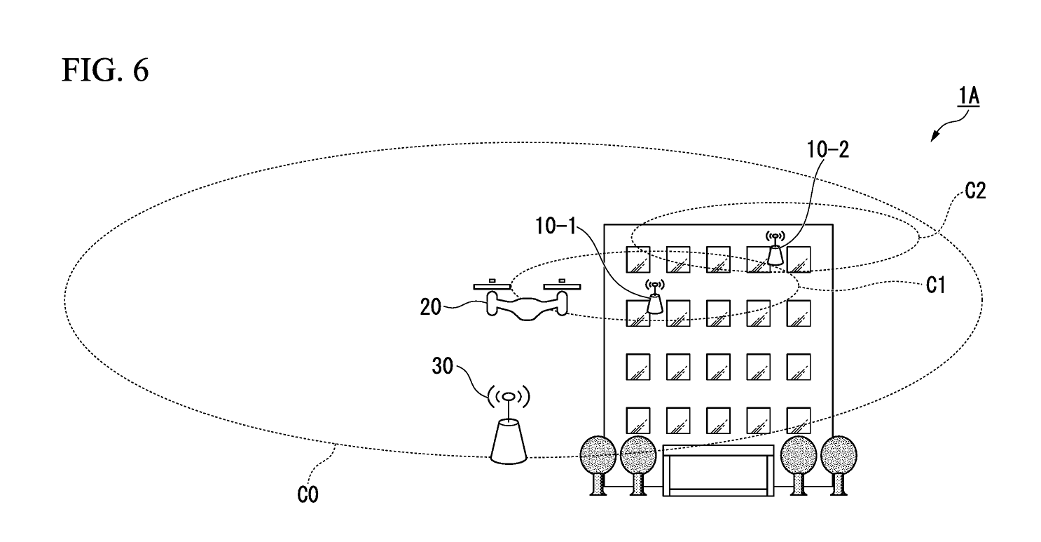

FIG. 6 is a schematic diagram illustrating an example of a configuration of the notification system 1A according to the third embodiment.

The notification system 1A according to the third embodiment includes a macrocell base station 30, in addition to the configuration of the notification system 1 according to the first embodiment or the second embodiment. Since other configurations are the same as those of the first embodiment or the second embodiment, description thereof will be omitted.

The macrocell base station 30 is a macrocell base station device (macrocell eNode B) that wirelessly transmits and receives data to and from a mobile station device. A radius of a cell to be provided by the macrocell base station 30 is in a relatively wide range of, for example, hundreds of meters to tens of kilometers. That is, the macrocell base station 30 is a base station device having a wide range in which communication with the mobile station device is possible (typically, a radius of hundreds of meters to tens of kilometers). The macrocell base station 30 communicably connects to the home base station 10 via a network.

A cell C0 illustrated in FIG. 6 is a cell that is provided by the macrocell base station 30. A cell C1 is a cell that is provided by the home base station 10-1. A cell C2 is a cell that is provided by the home base station 10-2. As illustrated in FIG. 6, the cell of the home base station 10 is a region of a part of the cell C0 of the macrocell base station 30.

Next, an overview of the notification system 1A will be described.

The unmanned aircraft 20 searches its surroundings to detect the macrocell base station 30 or the home base station 10 to which the unmanned aircraft 20 can connect, and performs flight while connecting to the detected macrocell base station 30 or the detected home base station 10. An operation in a case that the unmanned aircraft 20 connects to the home base station 10 is the same as that in the first embodiment or the second embodiment.

On the other hand, in a case that the unmanned aircraft 20 has connected to the macrocell base station 30, the macrocell base station 30 transmits a cell search request to the connected unmanned aircraft 20 to request search for a cell to which the unmanned aircraft 20 can connect. In a case that the unmanned aircraft 20 receives the cell search request from the macrocell base station 30, the unmanned aircraft 20 replies to the macrocell base station 30 with a cell search report for reporting the cell to which the unmanned aircraft 20 can connect, based on the informing information received from the home base station 10. In a case that the macrocell base station 30 receives the cell search report, the macrocell base station 30 transmits an unmanned aircraft approach notification for notifying the home base station 10 of the cell included in the received cell search report of the approach of the unmanned aircraft 20. In a case that the home base station 10 receives the unmanned aircraft approach notification from the macrocell base station 30, the home base station 10 outputs a warning message for notifying of the approach of the unmanned aircraft 20 through sound or a display. Accordingly, a person near the home base station 10 can know of the approach of the unmanned aircraft 20.

Next, a configuration of the macrocell base station 30 according to the third embodiment will be described.

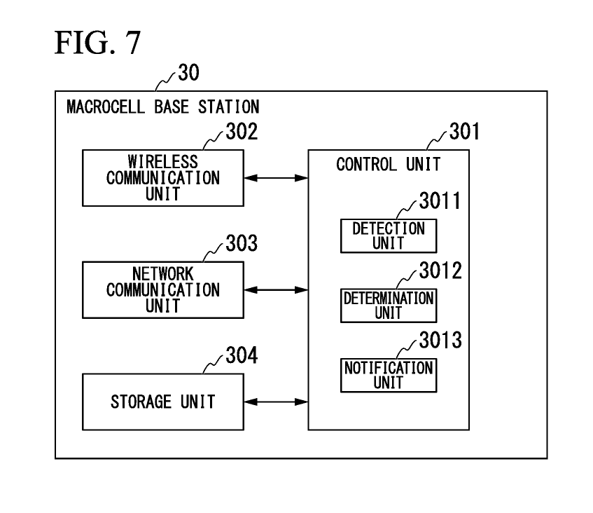

FIG. 7 is a schematic diagram illustrating an example of the configuration of the macrocell base station 30 according to the third embodiment. The macrocell base station 30 includes a control unit 301, a wireless communication unit 302, a network communication unit 303, and a storage unit 304.

The control unit 301 includes a detection unit 3011, a determination unit 3012, and a notification unit 3013, and controls the macrocell base station 30. The detection unit 3011 detects the approach of the mobile station device. For example, the detection unit 3011 detects the approach of the mobile station device based on the information that the mobile station device has transmitted based on the informing information transmitted by the home base station 10. More specifically, the detection unit 3011 detects that the mobile station device has approached the home base station 10 of the cell included in the cell search report received via the wireless communication unit 302, based on the cell search report. The determination unit 3012 determines whether or not the detected mobile station device is the unmanned aircraft 20. For example, the determination unit 3012 determines whether or not the mobile station device is the unmanned aircraft 20 based on the information transmitted from the mobile station device in the connection procedure or the unique identifier of the mobile station device included in the cell search report. In a case that it is determined that the mobile station device is the unmanned aircraft 20, the notification unit 3013 notifies of the approach of the mobile station device. For example, the notification unit 3013 transmits an unmanned aircraft approach notification to the home base station 10 of the cell included in the cell search report. That is, the notification unit 3013 notifies the home base station 10 that the unmanned aircraft 20 has detected based on the informing information transmitted by the home base station 10 of the approach of the unmanned aircraft 20.

The wireless communication unit 302 wirelessly communicates with the mobile station device. The network communication unit 303 communicates with a communication device such as the home base station 10 via a network. The storage unit 304 stores various types of information to be used by the macrocell base station 30.

Next, a notification process according to the third embodiment will be described.

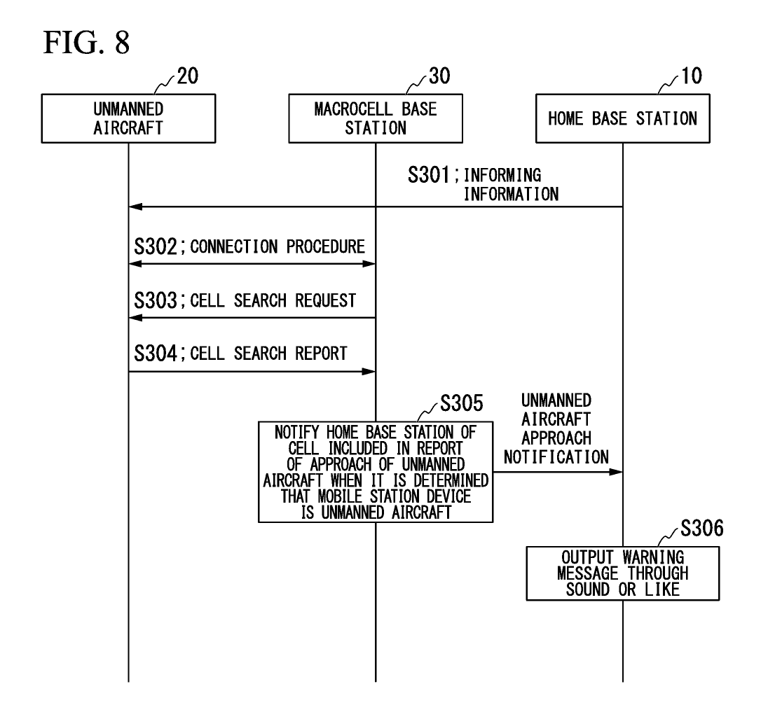

FIG. 8 is a sequence diagram illustrating the notification process according to the third embodiment.

(Step S301) The home base station 10 regularly transmits informing information. The unmanned aircraft 20 receives the informing information transmitted from the home base station 10.

(Step S302) The unmanned aircraft 20 performs a connection procedure with the macrocell base station 30. The macrocell base station 30 determines whether or not a mobile station device that has made the connection procedure is the unmanned aircraft 20.

(Step S303) The macrocell base station 30 transmits a cell search request to the unmanned aircraft 20.

(Step S304) In a case that the unmanned aircraft 20 receives the cell search request, the unmanned aircraft 20 generates a cell search report based on the informing information received from the home base station 10 and transmits the generated cell search report to the macrocell base station 30.

(Step S305) In a case that the macrocell base station 30 receives the cell search report, the macrocell base station 30 transmits an unmanned aircraft approach report to the home base station 10 of a cell included in the cell search report.

(Step S306) In a case that the home base station 10 receives the unmanned aircraft approach report, the home base station 10 outputs a warning message for notifying of the approach of the unmanned aircraft 20 through sound or the like. Thereafter, the process ends.

As described above, according to the third embodiment, the notification system 1A includes the home base station 10, the unmanned aircraft 20, and the macrocell base station 30. The macrocell base station 30 includes the detection unit 3011 that detects the approach of the mobile station device, the determination unit 3012 that determines whether or not the detected mobile station device is the unmanned aircraft 20, and the notification unit 3013 that notifies of the approach of the mobile station device in a case that it is determined that the mobile station device is the unmanned aircraft 20. The unmanned aircraft 20 transmits a cell search report to the macrocell base station 30 based on the informing information of which the home base station 10 has informed. The notification unit 3013 of the macrocell base station 30 notifies the home base station 10 of the cell included in the cell search report received from the unmanned aircraft 20 of the approach of the unmanned aircraft 20. The notification unit 1013 of the home base station 10 having received the notification of the approach of the unmanned aircraft 20 causes the sound output unit 105 or the display unit 106 to output the warning message for notifying of the approach of the unmanned aircraft 20.

Accordingly, it is possible to output the warning message to the home base station 10 with which the unmanned aircraft 20 is in approach, by interworking the macrocell base station 30 with the home base station 10 even in a case that the unmanned aircraft 20 is present within the cell of the home base station 10, but connects to the macrocell base station 30, in addition to the effects of the first embodiment or the second embodiment. Accordingly, it is possible to notify of the approach of the unmanned aircraft 20 without information on a target being input to the unmanned aircraft 20 in advance. Therefore, it is possible to output a warning about the approach of an unknown unmanned aircraft 20.

### Fourth Embodiment

Next, a fourth embodiment of the present invention will be described.

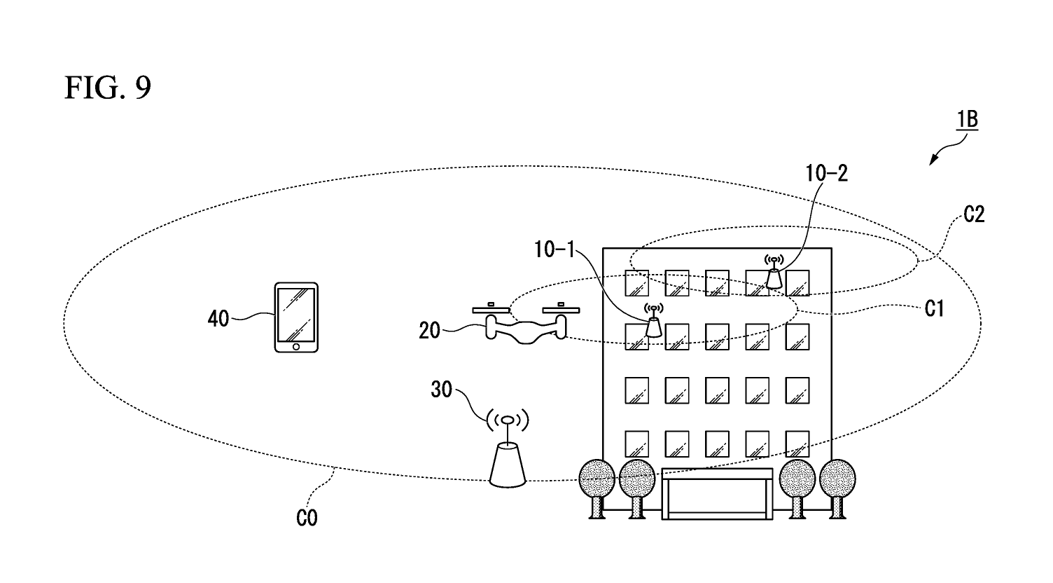

FIG. 9 is a schematic diagram illustrating an example of a configuration of a notification system 1B according to the fourth embodiment.

The notification system 1B according to the fourth embodiment includes a communication terminal 40 in addition to the configuration of the notification system 1A according to the third embodiment. The unmanned aircraft 20 and the communication terminal 40 are in the cell C0 provided by the macrocell base station 30. Here, the unmanned aircraft 20 and the communication terminal 40 perform long term evolution (LTE) device to device (D2D) communication to perform direct communication without passing through a base station device. Since other configurations are the same as those of the third embodiment, description thereof will be omitted.

The communication terminal 40 is a mobile station device that wirelessly transmits and receives data to and from the macrocell base station 30. The communication terminal 40 is, for example, a mobile phone, a smart phone, a personal digital assistant (PDA). In the fourth embodiment, the number of the communication terminals 40 is not limited to one as illustrated, and may be more than one.

Next, an overview of the notification system 1B will be described.

The unmanned aircraft 20 searches for surroundings to detect the macrocell base station 30 or the home base station 10 to which the unmanned aircraft 20 can connect, and performs flight while connecting to the detected macrocell base station 30 or the detected home base station 10. An operation in a case that the unmanned aircraft 20 connects to the macrocell base station 30 or the home base station 10 is the same as in the first to third embodiments.

The communication terminal 40 transmits interest information registration for the approach of the unmanned aircraft 20 to the macrocell base station 30. An identifier (ProSe Application ID) indicating content to be informed, a unique identifier (UE Identity) of the mobile station device, and a message type (Command) are included in the interest information registration. A value indicating the approach of the unmanned aircraft 20 is set in the identifier indicating the content to be informed. Further, the message type is “monitor”. In a case that the macrocell base station 30 receives the interest information registration from the communication terminal 40, the macrocell base station 30 replies to the communication terminal 40 with reception filter assignment. A value (Discovery Filter) for determining whether or not a discovery message is a message for informing of the approach of the unmanned aircraft 20 is included in the reception filter assignment. A value (ProSe Application Code (message identifier)) indicating that the discovery message is a message for informing of the approach of the unmanned aircraft 20 is included in the Discovery Filter.

On the other hand, in a case that the unmanned aircraft 20 performs handover to the macrocell base station 30, the unmanned aircraft 20 transmits a message registration for the approach of the unmanned aircraft 20 to the macrocell base station 30. An identifier (ProSe Application ID) indicating content to be informed, a unique identifier (UE Identity) of the mobile station device, and a message type (Command) are included in the message registration. A value indicating the approach of the unmanned aircraft 20 is set in the identifier indicating the content to be informed. Further, the message type is “announce”. In a case that the macrocell base station 30 receives the message registration from the unmanned aircraft 20, the macrocell base station 30 replies the unmanned aircraft 20 with transmission message assignment. A value (ProSe Application Code) to be temporarily assigned to the ProSe Application ID and used for the discovery message is included in the transmission message assignment. A value indicating that the discovery message is a message for informing of the approach of the unmanned aircraft 20 is set in the ProSe Application Code.

The unmanned aircraft 20 transmits the discovery message including the ProSe Application Code assigned in the transmission message assignment to the communication terminal 40.

In a case that the received discovery message includes the ProSe Application Code assigned in the reception filter assignment, the communication terminal 40 determines that the unmanned aircraft 20 has approached, and transmits a warning message for notifying of the approach of the unmanned aircraft 20 through sound or a display. Accordingly, a user of the communication terminal 40 can know of the approach of the unmanned aircraft 20.

That is, in a case that the detection unit 3011 of the macrocell base station 30 in the third embodiment receives the message registration via the wireless communication unit 102, the detection unit 3011 determines that the mobile station device has approached. Further, the determination unit 3012 determines whether or not the mobile station device is the unmanned aircraft 20 based on the unique identifier of the mobile station device included in the message registration. The notification unit 3013 notifies the communication terminal 40 of the approach of the unmanned aircraft 20 by transmitting transmission message assignment for the message registration to the unmanned aircraft 20. That is, the notification unit 3013 assigns, to the unmanned aircraft 20, a transmission message for transmitting an indication indicating that the message for notifying of the approach of the unmanned aircraft 20 is received, to the registered communication terminal 40. For example, the notification unit 3013 assigns a message identifier and transmits the assigned message identifier to the unmanned aircraft 20 and the communication terminal 40 via the wireless communication unit 102.

The control unit 201 of the unmanned aircraft 20 in the third embodiment informs of the approach notification from the wireless communication unit 202 using the transmission message assigned from the macrocell base station 30.

For example, the control unit 201 receives the message identifier transmitted by the macrocell base station 30, via the wireless communication unit 202. The control unit 201 informs of an approach notification including the received message identifier via the wireless communication unit 202.

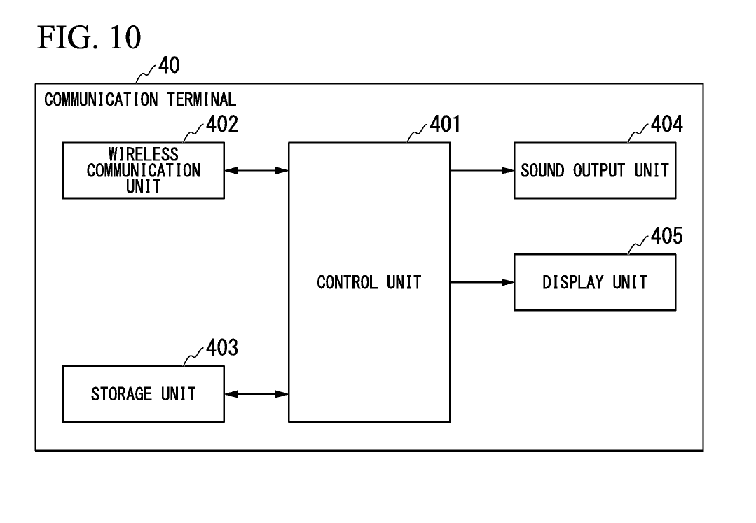

FIG. 10 is a schematic diagram illustrating an example of a configuration of the communication terminal 40 according to the third embodiment. The communication terminal 40 includes a control unit 401, a wireless communication unit 402, a storage unit 403, a sound output unit 404, and a display unit 405.

The control unit 101 controls the communication terminal 40. For example, in a case that the control unit 401 has received, via the wireless communication unit 402, the approach notification of which the unmanned aircraft 20 has informed using the transmission message assigned from the macrocell base station 30, the control unit 401 causes the sound output unit 404 to output a warning message (information on approach) for notifying of the approach of the unmanned aircraft 20 as sound. Alternatively, the control unit 401 causes the display unit 405 to display the warning message for notifying of the approach of the unmanned aircraft 20.

The wireless communication unit 402 wirelessly communicates with the unmanned aircraft 20 or the base station device. The storage unit 403 stores various pieces of data to be used by the communication terminal 40. The sound output unit 404 is a speaker that outputs sound. The display unit 405 includes an LED or a liquid crystal display and displays information.

The sound output unit 404 or the display unit 405 constitutes an output unit that outputs information on the approach of the unmanned aircraft 20.

Next, a notification process according to the third embodiment will be described.

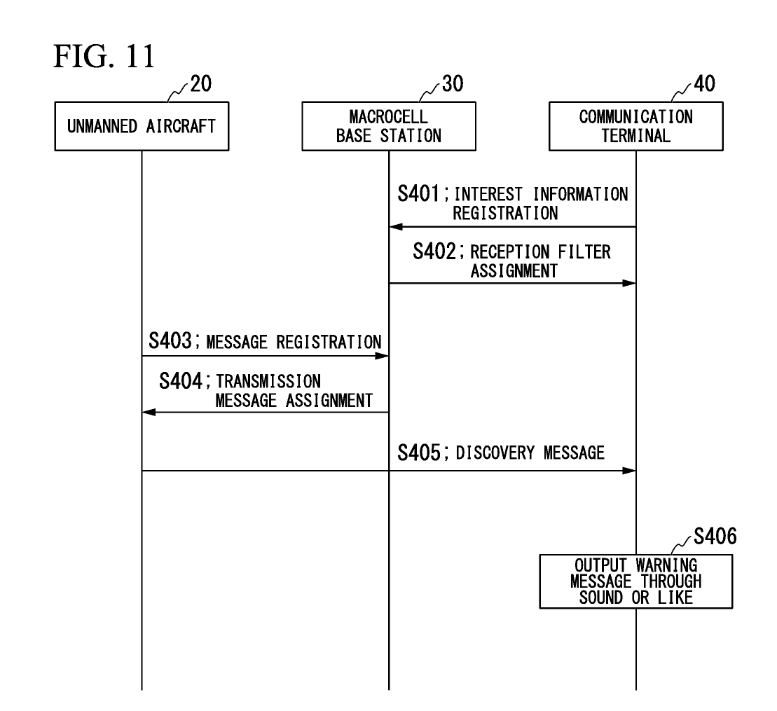

FIG. 11 is a sequence diagram illustrating the notification process according to this embodiment.

(Step S401) The communication terminal 40 transmits the interest information registration for the approach of the unmanned aircraft 20 to the macrocell base station 30.

(Step S402) In a case that the macrocell base station 30 receives the interest information registration, the macrocell base station 30 transmits reception filter assignment to the received interest information registration to the communication terminal 40.

(Step S403) The unmanned aircraft 20 transmits message registration for the approach of the unmanned aircraft 20 to the macrocell base station 30.

(Step S404) In a case that the macrocell base station 30 receives the message registration, the macrocell base station 30 transmits transmission message assignment for the received message registration to the unmanned aircraft 20.

(Step S405) The unmanned aircraft 20 transmits a discovery message based on the received transmission message assignment.

(Step S406) In a case that the communication terminal 40 receives the discovery message corresponding to the reception filter assigned in step S402, the communication terminal 40 determines that the unmanned aircraft 20 has approached, and transmits a warning message for notifying of the approach of the unmanned aircraft 20 through sound or the like. Thereafter, the process ends.

It should be noted that the processes of steps S401 to S402 described above may be performed at any time before step S405 and, for example, may be performed between the step S403 and the step S404 or after the step S404.

As described above, according to the third embodiment, the notification system 1B includes the home base station 10, the unmanned aircraft 20, the macrocell base station 30, and the communication terminal 40. The macrocell base station 30 includes the detection unit 3011 that detects the approach of the mobile station device, the determination unit 3012 that determines whether or not the detected mobile station device is the unmanned aircraft 20, and the notification unit 3013 that notifies of the approach of the unmanned aircraft 20 in a case that it is determined that the mobile station device is the unmanned aircraft 20. The notification unit 3013 assigns, to the unmanned aircraft 20, a message for transmitting an indication indicating that the message for notifying of the approach of the unmanned aircraft 20 is received, to the registered communication terminal 40. The unmanned aircraft 20 informs of an approach notification using the message assigned from the macrocell base station 30. In a case that the communication terminal 40 receives the approach notification from the unmanned aircraft 20, the communication terminal 40 outputs information on the approach of the unmanned aircraft 20.

Accordingly, the unmanned aircraft 20 can notify only the communication terminal 40 to which the reception filter has been assigned, of the approach using the transmission message, in addition to the effects of the first to third embodiments. Therefore, it is possible to notify only a person requesting the notification of the approach of the unmanned aircraft 20.

It should be noted that some of the units, such as the control unit 101, the control unit 201, the control unit 301, or the control unit 401, of the home base station 10, the unmanned aircraft 20, the macrocell base station 30, and the communication terminal 40 in the above embodiments is realized by a computer. In this case, the control unit may be realized by recording a program for realizing a control function thereof on a computer-readable recording medium, loading the program recorded on the recording medium into a computer system, and executing the program. It should be noted that the “computer system” described herein is a computer system built into the home base station 10, the unmanned aircraft 20, the macrocell base station 30, or the communication terminal 40 and includes an operating system (OS) or hardware such as a peripheral device. Further, the “computer-readable recording medium” refers to a portable medium such as a flexible disk, a magneto-optical disc, a ROM, or a CD-ROM, or a storage device such as a hard disk built into the computer system. Further, the “computer-readable recording medium” may also include a recording medium that dynamically holds a program for a short period of time, such as a communication line in a case that the program is transmitted over a network such as the Internet or a communication line such as a telephone line or a recording medium that holds a program for a certain period of time, such as a volatile memory inside a computer system including a server and a client in such a case. Further, the program may be a program for realizing some of the above-described functions or may be a program capable of realizing the above-described functions in combination with a program previously stored in the computer system.

Further, some of the units, such as the control unit 101, the control unit 201, the control unit 301, or the control unit 401, of the home base station 10, the unmanned aircraft 20, the macrocell base station 30, or the communication terminal 40 in the respective embodiments described above may be realized as an integrated circuit such as large scale integration (LSI). Further, for example, the control unit 101, the control unit 201, the control unit 301, and the control unit 401 may be integrated and realized as a processor. Further, an integrated circuit realization scheme is not limited to the LSI and the control unit may be realized as a dedicated circuit or a general-purpose processor. Further, in a case in which an integrated circuit realization technology with which the LSI is replaced appears with the advance of a semiconductor technology, an integrated circuit according to the technology may be used.

Although the embodiments of the present invention have been described in detail with reference to the drawings, specific configurations are not limited to those described above, and various design modifications and the like are possible without departing from the gist of the present invention. For example, the respective configurations described in the first to fourth embodiments can be arbitrarily combined.

In the above-described embodiments, the home base station 10 or the macrocell base station 30 determines whether or not the mobile station device is the unmanned aircraft 20 based on the unique identifier of the mobile station device, but the present invention is not limited thereto, and the home base station 10 or the macrocell base station 3 may determine whether or not the mobile station device is the unmanned aircraft 20 based on other information. For example, the home base station 10 or the macrocell base station 30 may determine whether or not the mobile station device is the unmanned aircraft 20 based on an identifier indicating a model of the mobile station device. Alternatively, in a case that a value indicating the unmanned aircraft 20 is included in a parameter of the communication capability of the mobile station device, the home base station 10 or the macrocell base station 30 may determine whether or not the mobile station device is the unmanned aircraft 20 based on communication capability of the mobile station device. Alternatively, in a case that the value indicating the unmanned aircraft 20 is included in a parameter of the reason for a connection request, the home base station 10 or the macrocell base station 30 may determine whether or not the mobile station device is the unmanned aircraft 20 based on the reason for a connection request.

Further, in the above-described embodiments, the home base station 10 notifies of the approach of the unmanned aircraft 20 through sound output or a display, but a notifying method is not limited thereto. For example, the home base station 10 may display a warning message for notifying a mobile station device in the cell that is provided by the home base station 10 of the approach of the unmanned aircraft 20. Alternatively, the home base station 10 may transmit a mail for notifying of the approach of the unmanned aircraft 20 to a specific mail address.

(1) A base station device including a detection unit that detects the approach of a mobile station device, a determination unit that determines whether or not the detected mobile station device is an unmanned aircraft, and a notification unit that notifies of the approach of the mobile station device in a case that it is determined that the mobile station device is an unmanned aircraft.

(2) The base station device according to (1), wherein the detection unit detects the approach of the mobile station device based on information which has been transmitted from the mobile station device based on informing information transmitted by the base station device.

(3) The base station device according to (1) or (2), including an output unit, wherein the notification unit causes the output unit to output information on the approach of the mobile station device.

(4) The base station device according to any one of (1) to (3), wherein the notification unit notifies other base station devices of the approach of the mobile station device.

(5) The base station device according to any one of (1) to (4), wherein the base station device is a macrocell base station device, and the notification unit notifies a small base station device having a cell that is a part of a cell of the macrocell base station device of the approach of the mobile station device.

(6) The base station device according to (5), wherein the notification unit notifies the small base station device that the mobile station device has detected based on informing information transmitted by the small base station device of the approach of the mobile station device.

(7) A notification method in a base station device, the notification method including a detection step of detecting approach of a mobile station device; a determination step of determining whether or not the detected mobile station device is an unmanned aircraft; and a notification step of notifying of the approach of the mobile station device in a case that it is determined that the mobile station device is an unmanned aircraft.

(8) A notification system including an unmanned aircraft, a base station device, and a communication terminal, wherein the base station device includes a wireless communication unit and a control unit, the control unit of the base station device assigns a message identifier, and transmits the assigned message identifier to the unmanned aircraft and the communication terminal via the wireless communication unit, the unmanned aircraft includes a wireless communication unit and a control unit, the control unit of the unmanned aircraft receives a message identifier transmitted by the base station device via the wireless communication unit, and informs of an approach notification including the message identifier via the wireless communication unit, the communication terminal includes an output unit, a wireless communication unit, and a control unit, and the control unit of the communication terminal causes the output unit to output information on the approach of the unmanned aircraft in a case that the approach notification of which the unmanned aircraft has informed is received via the wireless communication unit.

(9) An unmanned aircraft including a wireless communication unit and a control unit, wherein the control unit receives a message identifier transmitted by a base station device via the wireless communication unit, and informs of an approach notification including the message identifier via the wireless communication unit.

(10) A communication terminal including an output unit, a wireless communication unit, and a control unit, wherein the control unit causes the output unit to output information on approach of an unmanned aircraft in a case that approach notification of which the unmanned aircraft has informed is received via the wireless communication unit.

### INDUSTRIAL APPLICABILITY

Some aspects of the present invention are applicable to, for example, a base station device, a notification method, a notification system, an unmanned aircraft, and a communication terminal in which it is necessary to notify of approach of the unmanned aircraft without information on a target being input to the unmanned aircraft in advance.

### DESCRIPTION OF THE REFERENCE SYMBOLS

1, 1A, 1B Notification system

10 Home base station

20 Unmanned aircraft

30 Macrocell base station

40 Communication terminal

101 Control unit

102 Wireless communication unit

103 Network communication unit

104 Storage unit

105 Sound output unit

106 Display unit

201 Control unit

202 Wireless communication unit

203 Storage unit

204 Imaging unit

205 Flight control unit

301 Control unit

302 Wireless communication unit

303 Network communication unit

304 Storage unit

401 Control unit

402 Wireless communication unit

403 Storage unit

404 Sound output unit

405 Display unit

1011, 3011 Detection unit

1012, 3012 Determination unit

1013, 3013 Notification unit

1. A base station device comprising:
a detection unit that detects approach of a mobile station device;
a determination unit that determines whether or not the detected mobile station device is an unmanned aircraft; and
a notification unit that notifies of the approach of the mobile station device in a case that it is determined that the mobile station device is an unmanned aircraft.

2. The base station device according to claim 1, wherein the detection unit detects the approach of the mobile station device based on information which has been transmitted from the mobile station device based on informing information transmitted by the base station device.

3. The base station device according to claim 1, the base station device comprising an output unit,
wherein the notification unit causes the output unit to output information on the approach of the mobile station device.

4. The base station device according to claim 1, wherein the notification unit notifies other base station devices of the approach of the mobile station device.

5. The base station device according to claim 1,
wherein the base station device is a macrocell base station device, and
the notification unit notifies a small base station device having a cell that is a part of a cell of the macrocell base station device of the approach of the mobile station device.

6. The base station device according to claim 5, wherein the notification unit notifies the small base station device that the mobile station device has detected based on informing information transmitted by the small base station device of the approach of the mobile station device.

7. A notification method in a base station device, the notification method comprising:
detecting approach of a mobile station device;
determining whether or not the detected mobile station device is an unmanned aircraft; and
notifying of the approach of the mobile station device in a case that it is determined that the mobile station device is an unmanned aircraft.

8. A notification system comprising an unmanned aircraft, a base station device, and a communication terminal,
wherein the base station device comprises a first wireless communication unit and a first control unit,
the first control unit of the base station device
assigns a message identifier, and
transmits the assigned message identifier to the unmanned aircraft and the communication terminal via the first wireless communication unit,
the unmanned aircraft comprises a second wireless communication unit and a second control unit,
the second control unit of the unmanned aircraft
receives a message identifier transmitted by the base station device via the second wireless communication unit, and
informs of an approach notification including the message identifier via the second wireless communication unit,
the communication terminal comprises an output unit, a third wireless communication unit, and a third control unit, and
the third control unit of the communication terminal causes the output unit to output information on the approach of the unmanned aircraft in a case that the approach notification of which the unmanned aircraft has informed is received via the third wireless communication unit.

9. An unmanned aircraft comprising a wireless communication unit and a control unit,
wherein the control unit
receives a message identifier transmitted by a base station device via the wireless communication unit, and
informs of an approach notification including the message identifier via the wireless communication unit.

10. A communication terminal comprising an output unit, a wireless communication unit, and a control unit,
wherein the control unit causes the output unit to output information on approach of an unmanned aircraft in a case that approach notification of which the unmanned aircraft has informed is received via the wireless communication unit.
